(19) United States
(12) Patent Application Publication
(10) Pub. No.: US 2014/0002410 A1
(43) Pub. Date: Jan. 2, 2014

(54) FULLY ADDRESSABLE TRANSMITTER ELECTRODE CONTROL

(71) Applicants: Jeffrey Lillie, Mendon, NY (US); John Childs, Rochester, NY (US); Christopher Ludden, Pittsford, NY (US)

(72) Inventors: Jeffrey Lillie, Mendon, NY (US); John Childs, Rochester, NY (US); Christopher Ludden, Pittsford, NY (US)

(73) Assignee: Synaptics Incorporated, Santa Clara, CA (US)

(21) Appl. No.: 13/539,145

(22) Filed: Jun. 29, 2012

(51) Int. Cl. G06F 3/044

(52) U.S. Cl. 345/174

(57) ABSTRACT

Circuit architecture is provided to allow for flexible touch transmit signaling of a display device having an integrated capacitive sensing device. The circuit architecture includes an addressable selection module for non-sequentially selecting a plurality of transmitter electrodes to be driven for capacitive sensing. The circuit architecture supports a high voltage drive scheme that provides voltage sources for capacitive sensing and for updating the display device. The circuit architecture also supports a low voltage (logic level) drive scheme that provides a logic signal to be used by TFT circuitry to drive voltage signals for capacitive sensing and for updating the display device.

### BACKGROUND OF THE INVENTION

1. Field of the Invention

This invention generally relates to touch transmit signaling, and more specifically, to a touch transmit circuit architecture for a display device having an integrated capacitive sensing device.

2. Description of Related Art

Input devices including proximity sensor devices (also commonly called touchpads or touch sensor devices) are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

### BRIEF SUMMARY OF THE INVENTION

Embodiments presented in this disclosure include a display device having an integrated capacitive sensing device. The display device includes a plurality of transmitter electrodes disposed on a substrate within the display device. The plurality of transmitter electrodes comprises a plurality of common electrodes configured to operate in a first mode for capacitive sensing and configured to operate in a second mode for updating to the display device. The display device further includes an addressable selection module coupled to the plurality of common electrodes and a receiver module coupled to a plurality of receiver electrodes. The addressable selection module may be configured to non-sequentially select each of the plurality of transmitter electrodes to operate in the first mode and be driven for capacitive sensing. The receiver module may be configured to receive resulting signal while the transmitter electrodes are driven for capacitive sensing.

Additional embodiments include a processing system for a display device having an integrated capacitive sensing device. The processing system includes an addressable selection module coupled to a plurality of transmitter electrodes and a driver module comprising driver circuitry coupled to the addressable selection module. The addressable selection module may be configured to non-sequentially select one or more of the transmitter electrodes to be driven for capacitive sensing, wherein each of the plurality of transmitter electrodes comprises at least one of a plurality of common electrodes configured for performing both capacitive sensing functions and display update functions. The driver module may be configured to drive each of the plurality of transmitter electrodes for capacitive sensing and display updating. The processing system further includes a receiver module coupled to a plurality of receiver electrodes, the receiver module configured to receive a resulting signal from the receiver electrodes while the transmitter electrodes are driven for capacitive sensing.

Additional embodiments include a method of operating a display device having an integrated capacitive proximity sensor. The method includes receiving, from a driver module, a first logic signal for driving a plurality of transmitter electrodes disposed within a display element of the display device for performing capacitive sensing. The plurality of transmitter electrodes comprises a plurality of common electrodes configured for performing both capacitive sensing functions and display update functions. The method further includes selecting, by operation of an addressable selection module, each of the transmitter electrodes in a non-sequential manner according to the first logic signal to be driven for capacitive sensing, and receiving a resulting signal from a plurality of receiver electrodes while the transmitter electrodes are driven for capacitive sensing.

### BRIEF DESCRIPTION OF DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only embodiments of the invention and are therefore not to be considered limiting of its scope, for the invention may admit to other equally effective embodiments.

FIG. 1 is a schematic block diagram of an exemplary input device having an integrated display device, according to an embodiment described herein.

FIG. 2 is a schematic top view illustrating one example of an input device having a sensor electrode pattern used to sense positional information of an input object, according to one or more of the embodiments described herein.

FIG. 3 is a schematic diagram illustrating one example of an addressable selection module, according to an embodiment described herein.

FIG. 4 is a flow diagram illustrating a method for driving transmitter electrodes of an input device having an integrated display device, according to one embodiment of the invention.

FIG. 5 is a schematic diagram illustrating an embodiment of gate drive circuitry for the addressable selection module of FIG. 3, according to an embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

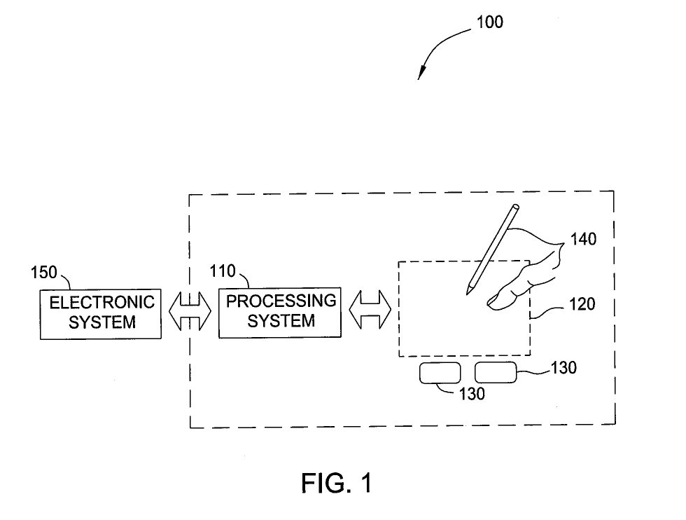

FIG. 1 is a block diagram of an exemplary of an input device 100 comprising a display device integrated with a sensing device, in accordance with embodiments of the invention. The input device 100 may be configured to provide input to an electronic system 150. As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system 150 could be a host or a slave to the input device.

The input device 100 can be implemented as a physical part of the electronic system 150, or can be physically separate from the electronic system 150. As appropriate, the input device 100 may communicate with parts of the electronic system 150 using any one or more of the following: buses, networks, and other wired or wireless interconnections. Examples include I²C, SPI, PS/2, Universal Serial Bus (USB), Bluetooth, RF, and IRDA.

In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g., a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques.

Some implementations are configured to provide images that span one, two, three, or higher dimensional spaces. Some implementations are configured to provide projections of input along particular axes or planes.

In FIG. 1, a processing system 110 is shown as part of the input device 100. The processing system 110 is configured to operate the hardware of the input device 100 to detect input in the sensing region 120. The processing system 110 comprises parts of or all of one or more integrated circuits (ICs) and/or other circuitry components. For example, a processing system for a mutual capacitance sensor device may comprise transmitter circuitry configured to transmit signals with transmitter sensor electrodes, and/or receiver circuitry configured to receive signals with receiver sensor electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the input (or lack of input) to some part of the electronic system 150 (e.g., to a central processing system of the electronic system 150 that is separate from the processing system 110, if such a separate central processing system exists). In some embodiments, some part of the electronic system 150 processes information received from the processing system 110 to act on user input, such as to facilitate a full range of actions, including mode changing actions and GUI actions.

For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system 150. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional”positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen of the display device. For example, the input device 100 may comprise substantially transparent sensor electrodes overlaying the display screen and provide a touch screen interface for the associated electronic system 150. The display screen of the display device may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The sensing device of the input device 100 and the display screen of the display device may share physical elements. For example, some embodiments may utilize some of the same electrical components for displaying and sensing. As another example, the display device comprising an integrated sensing device may be operated in part or in total by the processing system 110.

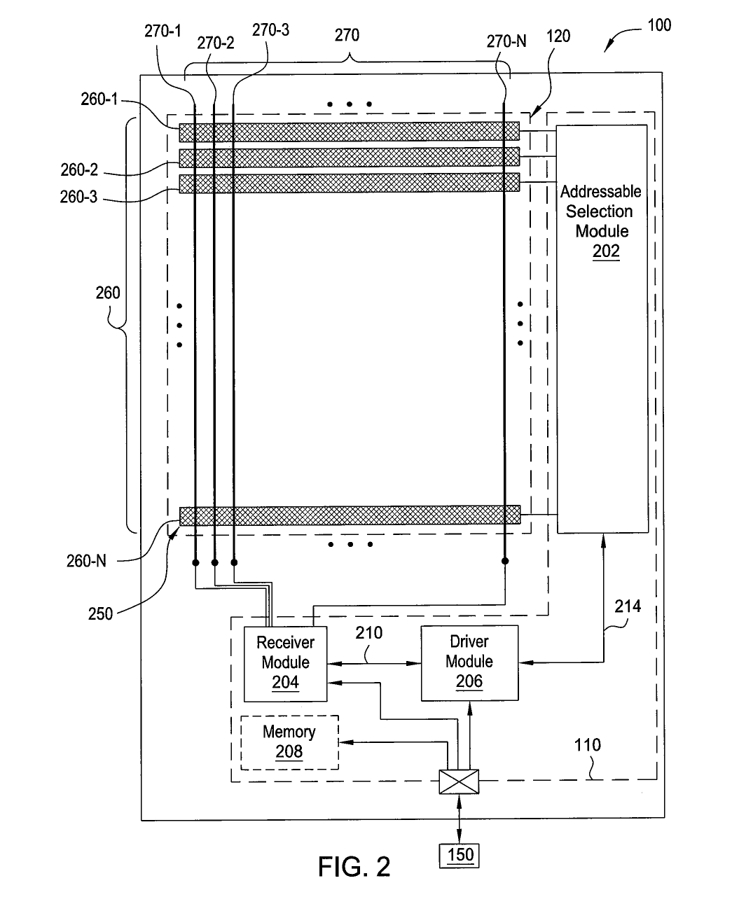

FIG. 2 is a schematic top view of the input device 100 illustrating a sensor electrode pattern 250 that may be used to sense the positional information of an input object 140 within the sensing region 120. For clarity of illustration and description, FIG. 2 illustrates the sensor electrode pattern 250 as a pattern of simple rectangles and thick lines, and does not show all of the interconnecting features and/or other related components. While FIG. 2 illustrates the sensor electrode pattern 250 as a pattern of simple rectangles and thick lines, this is not meant to be limiting and in other embodiments, various numbers, orientations and shapes for the sensor electrodes comprising the pattern 250 may be utilized.

The sensor electrode pattern 250 may be comprised of a plurality of transmitter electrodes 260 and a plurality of receiver electrodes 270. The transmitter electrodes 260 may be used to update parts of a display and for capacitive sensing, and thus are referred to herein as “common electrodes,” and the receiver electrodes 270 are configured to receive the resulting capacitive sensing signal(s) delivered through the common electrode(s), and thus are referred to herein as “receiver electrodes.” circuitry to sense (or not to sense), and/or the like.

In some embodiments, transmitter electrodes 260 and receiver electrodes 270 may be similar in size and/or shape. In one example, as shown, these sensor electrodes 260, 270 are disposed in the sensor electrode pattern 250 that comprises a first plurality of transmitter electrodes 260 (e.g., transmitter electrodes 260-1, 260-2, 260-3, etc.) and a second plurality of receiver electrodes 270 (e.g., receiver electrodes 270-1, 270-2, 270-3 . . . 270-N), which may disposed above, below, or on the same layer as the first plurality of transmitter electrodes 260. One will note that the sensor electrode pattern 250 of FIG. 2 may alternatively utilize various sensing techniques, such as mutual capacitive sensing, absolute capacitive sensing, elastive, resistive, inductive, magnetic acoustic, ultrasonic, or other useful sensing techniques, without deviating from the scope of the invention described herein.

Transmitter electrodes 260 and receiver electrodes 270 are typically ohmically isolated from each other. That is, one or more insulators separate transmitter electrodes 260 and receiver electrodes 270 and prevent them from electrically shorting to each other in regions where they may overlap. In some embodiments, transmitter electrodes 260 and receiver electrodes 270 are separated by electrically insulative material disposed between them at cross-over areas. In such configurations, the transmitter electrodes 260 and/or receiver electrodes 270 may be formed with jumpers connecting different portions of the same electrode. In some embodiments, transmitter electrodes 260 and receiver electrodes 270 are separated by one or more layers of electrically insulative material. In some other embodiments, transmitter electrodes 260 and receiver electrodes 270 are separated by one or more substrates, for example, they may be disposed on opposite sides of the same substrate, or on different substrates that are laminated together. In other some embodiments, transmitter electrodes 260 and receiver electrodes 270 may be similar in size and shape. In various embodiments, as will be discussed in more detail later, transmitter electrodes 260 and receiver electrodes 270 may be disposed on a single layer of a substrate. In yet other embodiments, other electrodes, including but not limited to, a shield electrode(s) may be disposed proximate to either transmitter electrodes 260 or receiver electrodes 270. The shield electrode may be configured to shield transmitter electrodes 260 and/or receiver electrodes 270 from interference such as nearby sources of driven voltages and/or currents. In some embodiments, the shield electrode(s) may be disposed with transmitter electrodes 260 and receiver electrodes 270 on a common side of a substrate. In other embodiments, the shield electrode(s) may be disposed with transmitter electrodes 260 on a common side of a substrate. In other embodiments, the shield electrode(s) may be disposed with receiver electrodes 270 on a common side of a substrate. In yet other embodiments, the shield electrode may be disposed on a first side of a substrate while transmitter electrodes 260 and/or receiver electrodes 270 are disposed on a second side, opposite the first.

In one embodiment, the areas of localized capacitive coupling between transmitter electrodes 260 and receiver electrodes 270 may be termed “capacitive pixels.” The capacitive coupling between the transmitter electrodes 260 and receiver electrodes 270 change with the proximity and motion of input objects in the sensing region associated with the transmitter electrodes 260 and receiver electrodes 270.

In some embodiments, the sensor pattern 250 is “scanned” to determine these capacitive couplings. That is, the transmitter electrodes 260 are driven to transmit transmitter signals. In other embodiments, as described herein, the sensor pattern 250 may be “non-sequentially” scanned to determine capacitive couplings, such any order of transmitter electrodes 260 (i.e., not just adjacent transmitter electrodes in a sequential order) may be driven to transmit transmitter signals.

The input device 100 may be operated such that one transmitter electrode transmits at one time, or multiple transmitter electrodes transmit at the same time. Where multiple transmitter electrodes transmit simultaneously, these multiple transmitter electrodes may transmit the same transmitter signal and effectively produce an effectively larger transmitter electrode, or these multiple transmitter electrodes may transmit different transmitter signals. For example, multiple transmitter electrodes may transmit different transmitter signals according to one or more coding schemes that enable their combined effects on the resulting signals of receiver electrodes 270 to be independently determined. The receiver electrodes 270 may be operated singly or multiply to acquire resulting signals (i.e., received capacitive sensing signals). The resulting signals may be used to determine measurements of the capacitive couplings at the capacitive pixels, which are used to determine whether an input object is present and its positional information, as discussed above. A set of values for the capacitive pixels form a “capacitive image” (also “capacitive frame” or “sensing image”) representative of the capacitive couplings at the pixels. Multiple capacitive images may be acquired over multiple time periods, and differences between them used to derive information about input object(s) in the sensing region. For example, successive capacitive images acquired over successive periods of time can be used to track the motion(s) of one or more input objects entering, exiting, and within the sensing region. In various embodiments, the sensing image, or capacitive image, comprises data received during a process of measuring the resulting signals received with at least a portion of the sensing elements 221 distributed across the sensing region 120. The resulting signals may be received at one instant in time, or by scanning the rows and/or columns of sensing elements distributed across the sensing region 120 in a raster scanning pattern (e.g., serially poling each sensing element separately in a desired scanning pattern), row-by-row scanning pattern, column-by-column scanning pattern or other useful scanning technique. In many embodiments, the rate that the “sensing image” is acquired by the input device 100, or sensing frame rate, is between about 60 and about 180 Hertz (Hz), but can be higher or lower depending on the desired application.

In some touch screen embodiments, the transmitter electrodes 260 and/or the receiver electrodes 270 are disposed on a substrate of the associated display device. For example, the transmitter electrodes 260 and/or the receiver electrodes 270 may be disposed on a polarizer, a color filter substrate, or a glass sheet of an LCD. In one embodiment, the transmitter electrodes 260 may be disposed within a display element of the display device comprised of at least a polarizer, a color filter substrate, and a glass sheet of an LCD. As a specific example, the transmitter electrodes 260 may be disposed on a TFT (Thin Film Transistor) substrate of an LCD, and may or may not also be used in display operations of the display device. As another example, the receiver electrodes 270 may be disposed on a color filter substrate, on an LCD glass sheet, on a protection material disposed over the LCD glass sheet, on a lens glass (or window), and the like. In those embodiments, where transmitter electrodes 260 and/or receiver electrodes 270 are disposed on a substrate within the display device (e.g., color filter glass, TFT glass, etc.), the sensor electrodes may be comprised of a substantially transparent material (e.g., ITO, ATO) or they may be comprised of an opaque material and aligned with the pixels of the display device (e.g., disposed such that they overlap with the “black mask” between pixel dots or a subpixel of the pixel).

In some touch screen embodiments, as shown in FIG. 2, transmitter electrodes comprise one or more common electrodes (e.g., segments of a segmented “V-corn electrode”), hereafter referred to as “common electrodes,” used in updating the display of the display screen. While the transmitter electrodes, or common electrodes, can be used to perform other capacitive sensing techniques, as discussed above, for clarity and simplicity of the discussion a common electrode capacitive sensing configuration is primarily used in the discussion below. These common electrodes may be disposed on an appropriate display screen substrate. For example, the common electrodes may be disposed on the TFT glass in some display screens (e.g., In Plane Switching (IPS) or Plane to Line Switching (PLS)), on the bottom of the color filter glass of some display screens (e.g., Patterned Vertical Alignment (PVA) or Multi-domain Vertical Alignment (MVA)), etc. In such embodiments, the common electrode can also be referred to as a “combination electrode,” since it performs multiple functions. In various embodiments, each transmitter electrode comprises one or more common electrodes. In other embodiments, at least two transmitter electrodes may share at least one common electrode.

In various embodiments, the common electrodes transmit signals for display updating and capacitive sensing in the same time period, or in different time periods. For example, the common electrodes may transmit signals for display updating during a display-update time of a row update cycle, and transmit signals for capacitive sensing during a non-display time of the row update cycle (e.g., sometimes called “horizontal blanking time”). In another example, the common electrodes may transmit signals for display updating during a display-update time of a row update cycle, and transmit signals for capacitive sensing during a multiple combined non-display times of the row update cycles (e.g., sometimes called “long horizontal blanking time” or “in-frame blanking time” or “distributed vertical blanking time”). As another example, the common electrodes may transmit signals for display updating during row update cycles with actual display row updates, and transmit signals for capacitive sensing during extra “row update cycles” without actual display row updates (e.g., the non-display times between updating sections of frames or entire frames, sometimes called “vertical blanking time”). Further, in various embodiments, the common electrodes may transit signals for capacitive sensing during any combination of the above non-display times. As a further example, the common electrodes may transmit signals simultaneously for display updating and capacitive sensing, but separate them spatially. As yet another example, the common electrodes may use the same transmission for both display updating and capacitive sensing.

In one embodiment, processing system 110 of input device 100 comprises an addressable selection module 202, a receiver module 204 and a driver module 206. As shown in FIG. 2, receiver module 204 is coupled to the receiver electrodes 270 so that it is able to receive the resulting signals from the receiver electrodes. In various embodiments, receiver module 204 is used to acquire sensor data (e.g., receive resulting signals). The receiver module 204 may be further configured to perform various calculations to help determine the positional information of an input object. While not shown, processing system 110 may further comprise a determination module configured to determine positional information for an input object in a sensing region of the display device based on the resulting signals. Driver module 206 is coupled with common electrodes, and comprises driver circuitry configured for displaying images on the display screen. The driver circuitry is configured to apply one or more pixel voltage(s) to the display pixel electrodes through pixel source drivers (not shown). The driver circuitry is also configured to apply one or more common drive voltage(s) to the common electrodes, and operate them as common electrodes of the display screen. The driver module 206 is also configured to operate the common electrodes as transmitter electrodes for capacitive sensing. In one embodiment, the driver module 206 provides control signals 214 to the addressable selection module 202, which in turn, drives the common electrodes to operate in a first mode for capacitive sensing, and to operate in a second mode for updating to the display screen of the display device. As described later, the driver module 206 may be configured to generate a logic signal comprising a substantially low voltage signal that may be used to drive the plurality of common electrodes for capacitive sensing and display update. In an alternative embodiment, the driver module 206 may be configured to generate a transmitter signal comprising a substantially high voltage signal onto each of the plurality of transmitter electrodes 260 for capacitive sensing.

While the processing system 110 illustrated in FIG. 2 comprises three modules, the processing system 110 may be implemented with more or less modules to control the various components in the input device. For example, the functions of the receiver module 204 and the driver module 206 may be implemented in one integrated circuit that can control the display module elements (e.g., common electrodes) and drive transmitter signals and/or receiver resulting signals transmitted with and/or received from the sensor pattern 250 (FIG. 2), which may comprise the receiver electrodes 270 and transmitter electrodes 260. In some configurations, the processing system 110 may comprise an addressable selection module 202, receiver module 204, a driver module 206, and memory 208 that are disposed within one or any number of ICs found in the processing system 100, depending to the desired processing architecture. In cases where there are more than one modules or ICs, synchronization between modules (e.g., receiver module 204 and driver module 206) may be achieved by communicating between these systems using a synchronization mechanism 212. In one embodiment, the synchronization mechanism 212 comprises a synchronization protocol that controls a number of functionality provided by the processing system 110, such as controlling oscillator frequency, transmitter signal pulses, and glass-specific features (e.g., enable/disable gate lines). In one example, the synchronization mechanism 212 may synchronize display updating cycle and capacitive sensing cycle by providing a synchronized clock, information about display update state, information about the capacitive sensing state, direction to display update circuitry to update (or not to update), direction to capacitive sensing circuitry to sense (or not to sense), and/or the like. In one embodiment, the process of synchronizing the components that are controlling the selection of common electrodes (e.g., addressable selection module 202) and the components that are controlling the creation of the sensing images (e.g., driver module 206, receiver module 204) may include sending periodic communications between these various components, such as control signals 214.

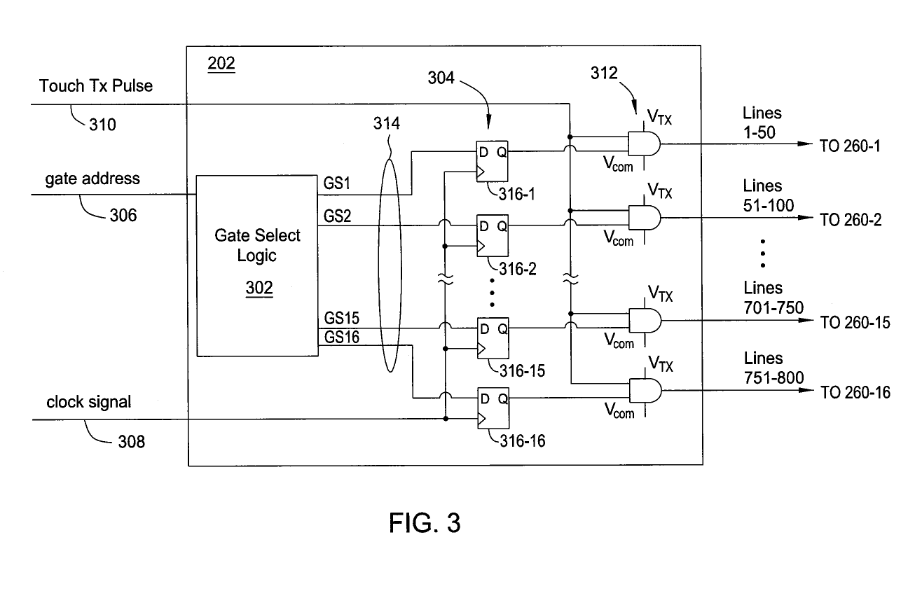

According to one embodiment, responsive to control signals from the driver module 206, the addressable selection module 202 is configured to apply one or more common drive voltage(s) to the transmitter electrodes 260, and operate them as common electrodes of the display screen. In some embodiments (e.g., line inversion embodiments), the addressable selection module 202 is configured to invert the common drive voltage in synchronization with a drive cycle of the image display. The addressable selection module 202 is further configured to operate common electrodes as transmitter electrodes for capacitive sensing. In one embodiment, the addressable selection module 202 is configured to non-sequentially select any combination of the common electrodes to be driven for capacitive sensing. In other embodiments, the common electrodes are configured to be scanned while the receiver electrodes 270 are receiving a signal from the common electrodes. The addressable selection module 202 is illustrated in greater detail in FIGS. 3-5 and is discussed further below.

FIG. 3 is a schematic diagram illustrating one example of the addressable selection module 202, according to one or more embodiments described herein. As described above, the driver module 206 provides control signals 214 (e.g., gate address 306, clock signal 308, touch transmit signal 310) to the addressable selection module 202 to select and drive transmitter electrodes 260, or groups of common electrodes. While the embodiment shown in FIGS. 2 and 3 includes a specific number of traces for the transmitter electrodes (e.g., 260-1, 260-2, . . . 260-N), it should be recognized that aspects of the present disclosure may be extended to cover any number of additional traces, for example, by adjusting the number of bits in gate address 306.

In one embodiment, the addressable selection module 202 includes circuitry disposed on a substrate within the display screen of the display device, such as a polarizer, a color filter substrate, or a glass or plastic sheet of an LCD or other type of display. In some embodiments, the addressable selection module 202 includes circuitry disposed on a same substrate having the transmitter electrodes 260 disposed thereon, such as the TFT glass substrate of an LCD. For sake of discussion, it may be assumed that the addressable selection module 202 comprises TFT circuitry on the display substrate that utilizes logic levels ranging from a first voltage potential to a FALSE logic level and to a second voltage potential corresponding to a TRUE logic level.

In one embodiment, the addressable selection module 202 includes gate select logic 302 connected by a memory bus 314 to a shift register 304 and gate drive circuitry 312 that provide voltage signals to the plurality of transmitter electrodes (e.g., 260-1, 260-2, . . . 260-N). The gate select logic 302 is configured to provide a plurality of gate signals (e.g., GS1, GS2, etc.) via the memory bus 314 to the shift register 304 based on a gate address 306 received from the driver module 206. In one embodiment, the gate select logic 302 may comprise a pre-programmed mapping of gate addresses 306 to gate signals. In one embodiment, the memory bus 314 comprises a plurality of parallel connections that provide a data path from the gate select logic 302 to the shift register. In one embodiment, the shift register 304 is comprised of a cascade of flip flops (illustrated as 316-1, 316-2, etc.) that have a parallel input of gate signals from the gate select logic 302 and that share a clock signal 308 provided by driver module 206. The output of each flip flop 316 is connected to gate drive circuitry 312.

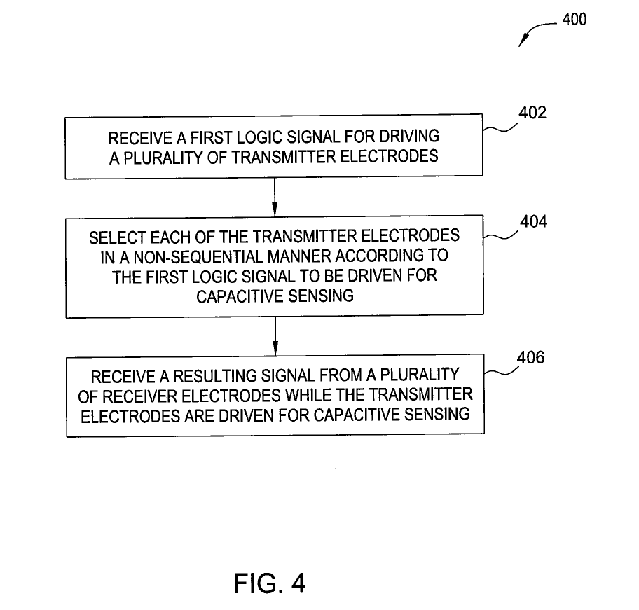

The gate drive circuitry 312 is connected to the plurality of common electrodes and is configured to drive groups of the common electrodes to a variety of voltage potentials. In one embodiment, gate drive circuitry 312 includes traces connected to groups of common electrodes that comprise each transmitter electrodes (e.g., 260-1, 260-2, etc.). For example, as shown in FIG. 3, a trace of the gate drive circuitry 312 may be connected to a bundle of common electrodes (e.g., “lines 1-50”) that comprise a first transmitter electrode 260-1. Though common electrodes are depicted as grouped into bundles of 50 segments of common electrodes (e.g., “lines 1-50,” “lines 751-800”), the number of common electrodes comprising a bundle may vary as desired. Accordingly, the gate drive circuitry 312 is configured to drive all the common electrodes that comprise a transmitter electrode (e.g., 260-1, 260-2, etc.) to a same voltage potential, under different modes of operation described herein. In one embodiment, the gate drive circuitry is configured to drive common electrodes to a voltage potential (referred to as “V_{COM}”) for updating the display device, and a voltage potential for capacitive sensing (referred to as “V_{TXP}” or simply “V_{TX}”), and in some embodiments, an inverse voltage potential for capacitive sensing (referred to as “V_{TXN}” or “˜V_{TX}”). In one embodiment, driving a common electrode to a voltage potential or capacitive sensing may comprise driving (or transitioning) the common electrode between a first and second voltage potential multiple times. In one specific implementation, V_{COM} and V_{TXN} are in the range of −1.0V to 0.0V, and the signal amplitude (e.g., V_{TX}-˜V_{TX}) for driving the common electrodes to transmit for capacitive sensing may be in the range of 3V to 10V. However, in other embodiments, other voltage potentials may be used. In one embodiment, the gate drive circuitry 312 is configured to provide voltage signals to a plurality of common electrodes based on the output of the shift register 304 (e.g., output of flip flops 316). The operation of the addressable selection module 202 is described further in FIG. 4.

FIG. 4 is a flow diagram illustrating a method 400 for driving transmitter electrodes of an input device 100 having an integrated display device, according to one embodiment of the invention. The method 400 begins at step 402 where the addressable selection module 202 receives a first logic signal for driving a plurality of transmitter electrodes.

In one embodiment, the gate select logic 302 receives, from the driver module 206, a logic signal comprising a gate address 306 to select at least one of plurality common electrodes. The gate address 306 indicates which of common electrodes (and transmitter electrodes 260) are to be driven. The gate address 306 may identify a single group of common electrode, a single group of common electrodes (e.g., “lines 1-50”) or multiple groups of common electrodes (to be driven at a same time). In some embodiments, the gate address 306 may be embodied as a value that identifies one or more pluralities of common electrodes. In one implementation, the gate address 306 may be a multi-bit value in which the individual bits identify corresponding common electrode(s). For example, the gate address 306 may be an 8-bit value, such as “8′b0100_{—}0000,” that corresponds to the common electrode(s) comprising transmitter electrode 260-2 being selected to be driven by the gate drive circuitry 312. In some embodiments, the gate address 306 may identify any arbitrary combination of one or more common electrodes. For example, the gate address 306 may have a value such as “01001000” that corresponds to transmitter electrodes 260-2, 260-5, 260-11 being selected to be driven at the same time by the gate drive circuitry 312.

At step 404, the addressable selection module 202 selects each of the transmitter electrodes in a non-sequential manner according to the first logic signal to be driven for capacitive sensing. In one embodiment, a “non-sequential” selection of transmitter electrodes may include selecting a series of non-adjacent transmitter electrodes 260. The “non-sequential” selection of transmitter electrodes may include selecting, over a given period of time, one or more transmitter electrodes 260 more often than other transmitter electrodes 260. In one embodiment, the “non-sequential” selection of transmitter electrodes may include a serial “scan” of the transmitter electrodes 260 wherein at least one transmitter electrode 260 has been omitted for selection. At step 406, the receiver module 204 receives a resulting signal from a plurality of receiver electrodes 270 while the transmitter electrodes 260 are driven for capacitive sensing.

In one embodiment, the gate select logic 302 determines a plurality of gate signals (e.g., GS1, GS2, etc.) based on the gate address 306 received from the driver module 206 and provides the gate signals to the shift register 304 via the memory bus 314. Continuing the example above, in response to receiving a gate address of “8′b0100_{—}1000” that corresponds to transmitter electrodes 260-2, 260-5, 260-11, the gate select logic 302 transmits a logical TRUE signal for GS2, GS5, and GS11, and a logical FALSE signal for the remaining gate signals. The flip flops 316 of the shift register 304 propagate the gate signals to the gate drive circuitry 312 based on the clock signal 308 received from the driver module 206.

In one embodiment, the output of the shift register 304 (e.g., output of flip flops 316) selects groups of common electrodes (e.g., transmitter electrodes 260-1, 260-2, etc.) to be driven. For example, the gate drive circuitry 312 drives any common electrodes connected to traces having an output of “1” from the shift register 304. Rather than drive common electrodes from top to bottom as in a conventional “scanning” approach, the shift register 304 may non-sequentially select groups of common electrodes to be driven for capacitive sensing.

In the embodiment shown in FIG. 3, after selecting groups of common electrodes to drive based on the output of shift register 304, the gate drive circuitry 312 determines a voltage signal (e.g., V_{COM}, V_{TX}, ˜V_{TX}, or another voltage potential) to provide to the selected common electrodes based on a touch transmit signal 310 provided by the driver module 206. The touch transmit signal 310 may be a logic drive signal that indicates whether to drive a particular group of common electrodes for capacitive sensing (e.g., V_{TX}) or for updating the display (e.g., V_{COM}). In one embodiment, the touch transmit signal 310 is a substantially low voltage signal having a first voltage potential and second voltage potential, the first voltage potential being higher than the second voltage potential. For example, in one implementation, the touch transmit signal 310 may be at a glass logic level (e.g., having voltage potentials from −6V to +15V). Each trace of the gate drive circuitry 312 drives a corresponding group of common electrodes to a voltage potential V_{TX} when a touch transmit signal 310 includes a logical TRUE value. When the touch transmit signal 310 includes a logical FALSE value, the gate drive circuitry 312 drives the selected groups of common electrodes to a voltage potential V_{COM}. In some embodiments, when one or more groups of common electrodes are driven to V_{TX}, the remainder of the common electrodes may be driven to V_{COM}. For example, if the shift register 304 selects the group of transmitter electrodes 260-2, and the touch transmit signal 310 is on, the gate drive circuitry may drive the group of transmitter electrodes 260-2 to V_{TX}, and drive the remaining groups of common electrodes (e.g., 260-1, 260-3, . . . 260-N) to V_{COM}.

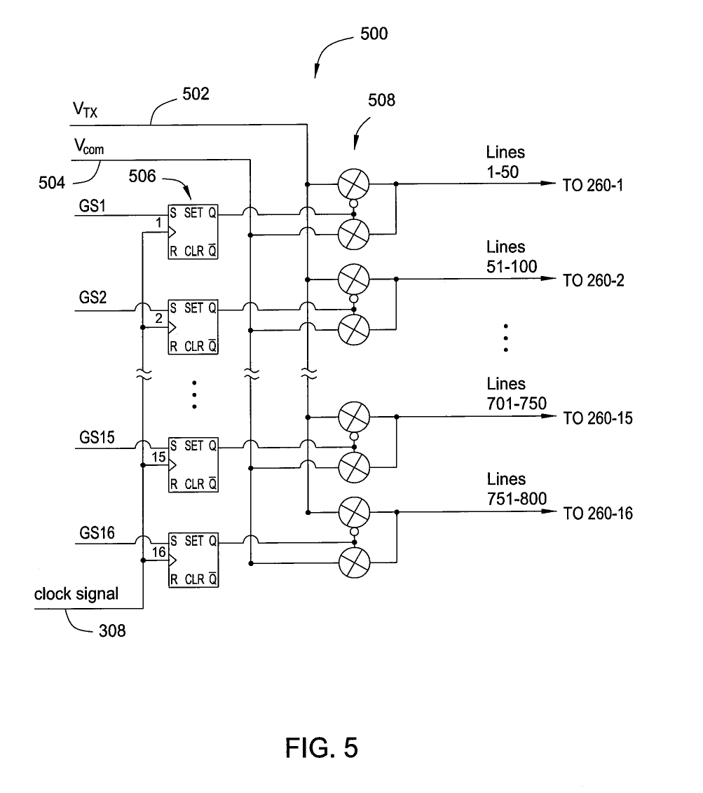

It may be noted that the above-described voltage scheme for the gate drive circuitry 312 enables a manufacturer of glass substrates and TFT circuitry (e.g., addressable selection module 202) disposed thereon to utilize a low-voltage logic signal provided by driver module 206 (e.g., touch transmit signal 310) while being able to provide their own voltage sources (not shown) and configure their own voltage potentials for V_{COM} and V_{TX}. Accordingly, the above described scheme for gate drive circuitry 312 may be referred to as a “low voltage (logic level) drive.” An alternative embodiment of the gate drive circuitry 312 may be referred to as “high voltage drive” scheme and is described in conjunction with FIG. 5.

FIG. 5 is a schematic diagram illustrating an alternative embodiment of gate drive circuitry 500 used with addressable selection module 202. The gate drive circuitry 500 is configured to non-sequentially select at least one group of common electrodes (e.g., transmitter electrodes 260-1, 260-2, etc.) based on the output of the shift register 304, and multiplex the selected group(s) of common electrodes between a voltage signal 504 providing V_{COM} and a transmitter signal 502 providing V_{TX}.

In the embodiment shown in FIG. 5, the transmitter signal 502 (e.g., V_{TX}) and the voltage signal 504 for V_{COM} are provided by the driver module 206, rather than be driven based on a logic signal 310 from the driver module 206 as in the gate drive circuitry 312 seen in FIG. 3. The transmitter signal 502 for V_{TX} comprises a substantially high voltage signal generated by the driver module 206 onto each of the plurality of transmitter electrodes for capacitive sensing. In one embodiment, the driver module 206 may be pre-configured to provide particular voltage potentials for V_{TX} and V_{COM} according to the specification for the receiver electrodes 270, display device, etc.

In one embodiment, the gate drive circuitry 500 includes a shift register 506 comprised of a cascade of flip flops that have a parallel input of gate signals (e.g., GS1, GS2, etc.) provided by the gate select logic 302 via the memory bus 314 and that share a clock signal 308 from the driver module 206 of driver module 206. The shift register 506 propagates the gate signals according to the clock signal 308 and provides the gate signals to circuitry that multiplexes between VCOM and VTX based on the gate signal. In the implementation shown in FIG. 5, the circuitry for multiplexing includes a plurality of XOR gates 508 configured to provide V_{TX} to a plurality of common electrodes when a gate signal (e.g., GS1) is on, and to provide V_{COM} otherwise.

In one embodiment, the addressable selection module 202 may be configured to drive at least one of a plurality of common electrodes with a first voltage potential for display updating and with a transmitter signal for capacitive sensing. In such an embodiment, the transmitter signal may be generated external from the addressable selection module 202 and coupled to each common electrode through the addressable selection module 202.

Accordingly, while the addressable selection module 202 may be used to drive each transmitter electrode from top to bottom, one at a time, to scan the sensor pattern, the addressable selection module 202 provides a fully addressable set of transmitters that enables any transmit pattern to be used. In one embodiment, the driver module 206 may use gate addresses 306 to elect any number of transmitter electrodes and any pattern in which the transmitter electrodes are driven, such as top-to-bottom or bottom-to-top. Further, the addressable selection module 202 advantageously allows for flexible power saving features by scanning only a subset or a portion of the transmitter electrodes for capacitive sensing. In one embodiment, if the electronic system 150 and/or input device 100 enters into a “locked” or “sleep” state, the addressable selection module 202 may be used to non-sequentially select each transmitter electrode 260 such that a portion of the transmitter electrodes are selected to be driven to scan a limited area of the sensing region 120 and detect a host input gesture which, e.g., corresponds to an “unlock” or “wake” gesture which is operable to transition the input device 100 from a locked state to an unlocked state. Accordingly, the addressable selection module 202 enables a low power 3-bit capacitive image on the display device. By scanning only the region where the 3-bit image is displayed for touch, the addressable selection module 202 saves power from not having to scan the entire sensor pattern. In yet another embodiment, the addressable selection module 202 may be used in absolutely sensing wherein the ability to drive a particular area of transmitter electrodes has an advantage for receiver channels.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

We claim:

1. A display device having an integrated capacitive sensing device, the display device comprising:
a plurality of transmitter electrodes disposed on a substrate within the display device, wherein the plurality of transmitter electrodes comprises a plurality of common electrodes configured to operate in a first mode for capacitive sensing and configured to operate in a second mode for updating to the display device;
an addressable selection module coupled to the plurality of common electrodes, the addressable selection module configured to non-sequentially select each of the plurality of transmitter electrodes to operate in the first mode and be driven for capacitive sensing; and
a receiver module coupled to a plurality of receiver electrodes, the receiver module configured to receive a resulting signal while the transmitter electrodes are driven for capacitive sensing.

2. The display device of claim 1, wherein the addressable selection module comprises at least one shift register.

3. The display device of claim 1, wherein the addressable selection module comprises a memory bus.

4. The display device of claim 1, further comprising:
a driver module coupled to the addressable selection module, the driver module configured to drive each of the plurality of transmitter electrodes for capacitive sensing.

5. The display device of claim 4, wherein the driver module is configured to generate a substantially low voltage signal having a first voltage potential and a second voltage potential, the first voltage potential being higher than the second voltage potential; and
wherein the driver module is configured to drive each of the plurality of transmitter electrodes for capacitive sensing by transitioning according to the substantially low voltage signal between the first voltage potential and the second voltage potential.

6. The display device of claim 4, wherein the driver module is configured to generate a substantially high voltage signal onto each of the plurality of transmitter electrodes for capacitive sensing.

7. The display device of claim 1, wherein the addressable selection module is configured to non-sequentially select each transmitter electrode such that only a portion of the plurality of transmitter electrodes are selected to be driven to detect a host input gesture.

8. The display device of claim 7, wherein the host input gesture is a unlock gesture operable to transition the display device from a locked state to an unlocked state.

9. The display device of claim 1, wherein the display device further comprises:
a determination module configured to determine positional information for an input object in a sensing region of the display device based on the resulting signal.

10. A processing system for a display device having an integrated capacitive sensing device, the processing system comprising:
an addressable selection module coupled to a plurality of transmitter electrodes, the addressable selection module configured to non-sequentially select one or more of the transmitter electrodes to be driven for capacitive sensing, wherein each of the plurality of transmitter electrodes comprises at least one of a plurality of common electrodes configured for performing both capacitive sensing functions and display update functions;
a driver module comprising driver circuitry coupled to the addressable selection module, wherein the driver module is configured to drive each of the plurality of transmitter electrodes for capacitive sensing and display updating; and
a receiver module coupled to a plurality of receiver electrodes, the receiver module configured to receive a resulting signal from the receiver electrodes while the transmitter electrodes are driven for capacitive sensing.

11. The processing system of claim 10, wherein the driver module is configured to generate a substantially low voltage signal having a first voltage potential and a second voltage potential, the first voltage potential being higher than the second voltage potential; and
wherein the driver module is configured to drive each of the plurality of transmitter electrodes for capacitive sensing by transitioning according to the substantially low voltage signal between the first voltage potential and the second voltage potential.

12. The processing system of claim 10, wherein the driver module is configured to generate a substantially high voltage signal onto each of the plurality of transmitter electrodes for capacitive sensing.

13. The processing system of claim 10, wherein the addressable selection module is configured to non-sequentially select one or more of the transmitter electrodes such that only a portion of the plurality of transmitter electrodes are selected to be driven to detect a host input gesture.

14. The processing system of claim 10, wherein the addressable selection module comprises at least one shift register.

15. The processing system of claim 10, wherein the addressable selection module comprises at least one memory bus.

16. The processing system of claim 10, wherein the processing system further comprises:
a determination module configured to determine positional information for an input object in a sensing region of the integrated capacitive sensing device based on the resulting signal.

17. A method of operating a display device having an integrated sensing device, the method comprising:
receiving, from a driver module, a first logic signal for driving a plurality of transmitter electrodes disposed within a display element of the display device for performing capacitive sensing, wherein the plurality of transmitter electrodes comprises a plurality of common electrodes configured for performing both capacitive sensing functions and display update functions;
selecting, by operation of an addressable selection module, each of the transmitter electrodes in a non-sequential manner according to the first logic signal to be driven for capacitive sensing; and
receiving a resulting signal from a plurality of receiver electrodes while the transmitter electrodes are driven for capacitive sensing.

18. The method of claim 17, further comprising:
generating, by operation of the driver module, a substantially low voltage signal having a first voltage potential and a second voltage potential, the first voltage potential being higher than the second voltage potential; and
driving each of the plurality of transmitter electrodes for capacitive sensing by transitioning according to the substantially low voltage signal between the first voltage potential and the second voltage potential.

19. The method of claim 18, further comprising:
generating a substantially high voltage signal onto each of the plurality of transmitter electrodes for capacitive sensing.

20. The method of claim 17, wherein the selecting each of the transmitter electrodes comprises non-sequentially selecting each transmitter electrode such that only a portion of the plurality of transmitter electrodes are selected to be driven to detect a host input gesture.
